(19) United States
(12) Patent Application Publication
(10) Pub. No.: US 2004/0110883 A1
(43) Pub. Date: Jun. 10, 2004

(54) Coloration of paper by binding colorants in a surface application

(76) Inventors: Dwight J. Pakan, Charlotte, NC (US); Richard L. Tyte SR., Charlotte, NC (US); John Pelletier, Mason, OH (US)

Correspondence Address: BASF CORPORATION, ANNE GERRY SABOURIN, 26701 TELEGRAPH ROAD, SOUTHFIELD, MI, 48034-2442, US

(21) Appl. No.: 10/680,650

(22) Filed: Oct. 7, 2003

Related U.S. Application Data
(60) Provisional application No. 60/419,757, filed on Oct. 18, 2002.

(51) Int. Cl. C08K 3/26

(52) U.S. Cl. 524/425; 524/431; 524/445; 524/451; 524/448; 524/503; 427/256

(57) ABSTRACT

The present invention relates to a method of coloring the surface of paper. A method is provided comprising providing a paper substrate; and applying a coloring composition comprising a binder and a coloring agent to form a colored paper, wherein the coloring composition is non-white.

### CROSS-REFERENCE TO RELATED APPLICATIONS

The present application claims priority to U.S. Provisional Application 60/419,757, filed on Oct. 18, 2002.

### BACKGROUND OF THE INVENTION

Papers are colored by mixing a coloring agent with a pulp mixture and then forming the paper. By mixing the coloring agent with the pulp, the paper has a uniform color throughout the entire paper. However, fibers not exposed to the sheet surface also are colored, but these colored fibers yield little to no value to the final appearance of the paper and consume coloring agent in the process.

Attempts have been made to color the entire surface of paper by applying a coloring agent at the surface. This would allow for white paper stock to be formed, and then individual colored papers can be produced in desired quantities. The problem with this process is that the coloring agent can rub off, or it can bleed when contacted with a liquid (such as, water, alcohol, solvents, or beverages). This is particularly noticeable when more than 50% of the total coloring agent for the paper is applied to the surface. Attempts have been made to reduce the rub and bleed effects by including a fixing agent with the coloring agent. This improves, but does not solve, the fixing of the color to the paper, and there is still some rub off and bleed. Also, many fixing agents dull the shade of the colorant.

It would be desirable to apply coloring agents to the surface of paper without dulling the shade of the colorant, and to fix the coloring agents to the paper. It is desirable to produce colored papers in the most cost effective method possible while at the same time maintaining physical and visual characteristics. Some of these characteristics include lightfastness, bleedfastness, and shade.

### SUMMARY OF THE INVENTION

The present invention relates to a method comprising providing a paper substrate; and applying a coloring composition comprising a binder and a coloring agent to form a colored paper, wherein the coloring composition is non-white.

### DETAILED DESCRIPTION

As used throughout, ranges are used as a shorthand for describing each and every value that is within the range. Any value within the range can be selected as the terminus of the range.

The present invention relates to the coloration of paper by applying a coloring composition entirely to the surface of the paper. The amount of coloring agent can be reduced by 30 to 70% when compared to mixing the coloring agent with the pulp to form a paper that is colored throughout. This method also allows paper to be colored with a desired color on demand, without the need for having to store colored paper in inventory to meet demands for a particular color.

The present invention provides a method comprising providing a paper substrate; and applying a coloring composition comprising a binder and a coloring agent to form a colored paper, wherein the coloring composition is non-white. Preferably, the coloring composition is an aqueous composition, and preferably, the coloring composition does not contain solvent.

The binder can be any material that can bind the coloring agent to the paper. Preferably, the binder that can be used includes, but is not limited to, a styrene butadiene polymer dispersion, a styrene butadiene acrylonitrile polymer dispersion, an acrylic polymer dispersion, a polyvinyl acetate, a polyvinyl acrylate, a starch, or combinations thereof. Preferably, the amount of binder in the coloring composition can range from about 0.1 to about 99.9% by weight of the total wet weight of the binder in the total coloring composition. More preferably, the binder is present in the coloring composition from about 5% to about 60% by weight of the total wet weight of the binder in the total coloring composition. Additional polymers that can be blended with the binders of the present invention include, but are not limited to, a polyurethane, a polyether, a polyester, a melamine-formaldehyde polymer, a vinyl halide, a vinylidene halide, a poly(ethyleneimine), a poly(vinyl amine), a poly(amine), a poly(imine), a poly(acrylate), and mixtures thereof.

Coloring agents that can be used include, but are not limited to, a direct dye, a basic dye, an acid dye, a reactive dye, a solvent dye, a dispersed dye, a leather dye, a natural dye, a sulfur dye a vat dye, a synthetic pigment, a naturally occurring pigment, a security dye, and mixtures thereof. Preferably, the coloring agent is a pigment. The amount of coloring agent is present in the coloring composition in any amount so that a desired color and shade are produced. Preferably, the coloring agent is present in an amount from about 0.01 to about 99.9% by weight of the total coloring composition. More preferably, the coloring agent is present in an amount from about 0.1 to about 50% by weight of the total coloring composition. Preferably, the coloring agent is included in the composition without a cationic fixing agent. While materials that would produce a white paper can be added, they are only added in an amount such that the coloring composition is non-white. In one embodiment, the color is non-white and includes a coloring agent or agents that change the level and/or wavelengths of the reflected light from the paper surface depending on viewing angle (the relative angle between the light source, paper surface and observer). Additionally, the color can be non-black.

The paper substrate can be any paper substrate, and the paper can have any desired thickness. Preferably, the paper is derived from plant materials. Plant materials include, but are not limited to wood pulp, plant fibers, and cotton fibers.

The coloring composition can further comprise at least one of a filler, a viscosity modifier, a dispersant, and a lubricant.

Fillers can be included to modify the surface appearance and physical properties of the paper. Preferably, the fillers that can be used include, but are not limited to, silica, calcium carbonate, chalk, clay, titanium dioxide, aluminum oxides, talc and diatomaceous earth, mica, kaolin, barium sulfate, magnesium carbonate, vermiculite, graphite, carbon black, and mixtures thereof. Preferably, the amount of filler can range from 0 to about 65% by weight of filler in the total weight of the coloring composition.

Viscosity modifiers are added as needed and are used to stabilize the coloring composition as well as improve the runnability on various metering applications. Viscosity modifiers that can be used include, but are not limited to, associative thickeners, alkali swellable thickeners, alkali soluble thickeners, polymer thickeners, and mixtures thereof. Examples of these types of viscosity modifiers include, but are not limited to, polyvinyl alcohol, cellulose derivatives such as hydroxyethyl cellulose, hydroxypropyl cellulose and carboxymethyl cellulose salt, polyether compounds, urethane modified polyether compounds, polycarboxylic acid compounds, sodium salts of polycarboxylic acid compounds, polyvinylpyrrolidone, polyoxyethylene derivatives such as polyethylene glycol ether and polyethylene glycol distearate, sodium alginate and inorganic materials such as sodium silicate and bentonite. Preferably, the viscosity modifier is present in the coloring composition in an amount from 0 to about 15% by weight based on the total weight of the coloring composition.

Dispersants and lubricants are added as needed to stabilize the coloring composition as well as improve runnability on various metering applications.

Dispersants that can be used include, but are not limited to, inorganic dispersing agents such as sodium salts of polycarboxylic acids, sodium or ammonium salts of fused naphthalene sulfonate, polyoxyalkylene alkyl ethers of phenol ether, sorbitan fatty acid esters, polyoxyalkylene fatty acid esters, glycerin fatty acid esters, polyoxyethylene styrene phenol, sodium tripolyphosphate, sodium hexametaphosphate, organosilanol derivatives of tung oil or linseed oil, high erucic acid rapeseed oil, and mixtures thereof. Preferably, the amount of dispersant ranges from 0 to about 10% by weight based on the total weight of the coloring composition.

Lubricants that can be used include, but are not limited to, calcium stearate, tall oil, polyethylene glycol, polyethylene emulsions, and mixtures thereof. Preferably, the amount of lubricant ranges from 0 to about 10% by weight based on the total weight of the coloring composition.

The coloring composition can further include a pH adjusting agent to adjust the pH to a desired value. The pH adjusting agent can be any pH adjusting agent that provides a desired pH. Examples of the pH adjusting agents include, but are not limited to, sodium hydroxide, potassium hydroxide, sodium hydrogen carbonate, ammonium hydroxide, ammonia, amines, triethanolamine, 3-dimethylaminoethanol, and mixtures thereof. The amount of the pH adjusting agent is selected such that the coloring composition has a desired pH.

The coloring composition can be applied to the surface of the paper by any surface application method. Surface applications include, but are not limited to, printing, spraying, sizepress, metering film press, coating operation, blade coating, short dwell coating, air knife coating, curtain coating, and rod coating.

Up to 100% of the final paper coloration can be derived from the surface application of the coloring composition. Preferably, when the coloring composition is applied at the surface only, the total amount of coloring agent needed to produce a desired color and shade can be reduced by 30% to 70% when compared to a typical internal or combined internal/surface application. Optionally, the coloring composition can be applied to a non-white paper substrate.

Papers colored by the method of the invention can achieve the following properties. With the proper selection of coloring agent, the colored paper can achieve a light fastness (as measured by test method BASF Lightfastness Test) of at least about 80 hours or more when required. For bleed (according to test method BASF Bleed Test, similar to TAPPI T475.cm85), the paper can achieve no bleed. For rub off (according to test method BASF Rub Test), the paper can achieve no rub off.

In the preferred application, the paper or paperboard is produced on a typical papermachine and the color composition is applied as a part of the papermaking process using surface application equipment or is applied following the paper production utilizing secondary surface application equipment.

### Specific Embodiments of the Invention

The invention is further described in the following examples. The examples are merely illustrative and do not in any way limit the scope of the invention as described and claimed.

### EXAMPLE 1

A coloring composition was prepared from 20 g of water, 0.5 g DESPEX™ N40V dispersant from Ciba, 10 g of SOLAR® T Blue 07L 150% pigment from BASF, 100 g of ACRONAL® S-504 binder from BASF, 1 g CALSAN® 50T lubricant (50% active) from BASF, and 1.1 g of STEROCOLL® FD thickener (25% active) from BASF. The materials were mixed, and the pH was adjusted to 8.5 with NaOH (Sample 1-1). The base paper used had an area of 15.24 cm×15.24 cm (6″×6″) or 0.02322576 m², a weight of 4.4931 g for a basis weight of 193.45 g/m².

The composition was drawn down on a paper board with a #8 wire wound rod. A uniform blue color was formed. The composition was applied at a rate of 10.87 g/m².

The composition was cut in half with water and was redrawn on paper (Sample 1-2). Penetration of the composition into the paper was increased because of the lower viscosity, but void areas were formed, and there was a reduction in shade depth. The composition was applied at a rate of 4.99 g/m².

To the composition, 1.1 g of STEROCOLL® FD thickener was added, and the pH was adjusted to 8.4 with NaOH (Sample 1-3). A draw down on paper still had void areas. The composition was applied at a rate of 2.47 g/m².

To the composition, 10 g of SOLAR® T BLUE 07L150% (C.I. Number Pigment Blue 14) pigment and 1.1 g of STEROCOLL® FD thickener were added, and the pH was adjusted to 8.5 with NaOH (Sample 1-4). The viscosity improved, but the void areas were still present. The depth of shade was good. The composition was applied at a rate of 11.23 g/m².

The coating weight is based on the dry weight of the coating composition that is applied to the paper.

The samples were tested for color properties and bleed fastness, and the results are shown in Table 1 below. The colored papers can be seen in FIG. 1. The test methods are described below.

TABLE 1

| | Color | | | | Bleed | Coating weight |
|---|---|---|---|---|---|---|
| Sample | L | a | b | Br | fastness | (g/m²) |
| 1-1 | 29.38 | 22.85 | −66.32 | 36.96 | 5, excellent | 10.87 |
| 1-2 | 36.85 | 18.75 | −65.25 | 49.13 | 5, excellent | 4.99 |
| 1-3 | 36.76 | 19.348 | −67.06 | 48.23 | 5, excellent | 2.47 |
| 1-4 | 29.72 | 22.11 | −64.01 | 36.54 | 5, excellent | 11.23 |

### EXAMPLE 2

A composition was prepared from 100 parts ACRONAL® S504 binder from BASF (50% solids), 2 g CALSAN® 50T lubricant (50% active) from BASF, 10 g of Solar T Blue 07L 150% pigment from BASF, and 2.2 g of STEROCOLL® FD thickener (25% active) from BASF, 4 g SAN-SIL® BD-73 from BASF (100% solids). Draw downs were performed using a number 8 (sample 2-1) yielding a visual matte finish with uniform coverage and a number 2 rod (sample 2-2) yielding a visually mottled appearance with insufficient surface coverage.

A second composition was prepared using 100 parts ACRONAL® NX4787X binder from BASF (50% solids), 2 g CALSAN® 50T lubricant (50% active) from BASF, 10 g of Solar T Blue 07L 150% pigment, and 2.2 g of STEROCOLL® FD thickener (25% active) from BASF. The materials were mixed, and the pH was adjusted to 9.0 with NaOH.

The viscosity of composition 2 was determined to be too high for known application methods so the STEROCOLL® FD thickener was reduced to 1.1 g yielding composition 3. Draw downs were performed for composition 3 using a Number 2 rod (sample 2-3) and a number 4 rod (sample 2-4). The resulting samples were visually evaluated for uniformity, color depth and shade, gloss, and mottle. This experiment demonstrated the ability to modify the composition to achieve/alter uniformity, color depth and shade, gloss, and mottle. Samples 2-3 and 2-4 both had visually uniform coverage and glossy surfaces.

It was observed that the silica reduced the tackiness of the binder, dulled the gloss, and improved viscosity to eliminate void areas. It was also calculated that the coloring agent required to achieve the coloration of sample 2-2 was approximately 2.27 kg (5 lbs.) of coloring agent per 908 kg (ton) of finished paper. Under normal internal coloring agent application conditions, it was determined that approximately 45.4 kg (100 lbs.) of coloring agent per 908 kg (ton) of finished paper would be required to achieve the same depth of shade.

The composition was applied to 5.08 cm×5.08 cm (2″×2″) papers. Composition 1 was applied using a #2 rod at 0.99 g/m² (Sample 2-1), and a #8 rod at 2.70 g/m² (Sample 2-2)

Composition 3 was applied to the 5.08 cm×5.08 cm (2″×2″) papers using a #2 rod at 1.03 g/m² (Sample 2-3) and a #4 rod at 5.59 g/m² (Sample 2-4).

### EXAMPLE 3

Using composition 3, the Solar T Blue 07L 150% was replaced with FASTUSOL® Yellow 76LN (C.I Direct Yellow 11) dye from BASF. Draw downs using #2 and #4 rods (Samples 3-1 and 3-2) were performed yielding an application rate of 1 g/m² and 5.6 g/m², respectively. The samples yielded a visually uniform shade and color depth. A third colored paper sample (3-3) was prepared by coloring the paper. The method utilized 2 g FASTUSOL® Yellow 76LN dye in 200 g water, and a white paper sample was submerged in this solution per the current standard surface color application methods (BASF Dip Dyeing Method). The samples 3-2, 3-3 were then evaluated for bleedfastness to water (using the BASF Bleed Fastness Test). Sample 3-2 yielded a result of 4 (Slight bleed) and the 3-3 sample yielded a result of 1 (Much bleed). The yellow dye for this experiment was chosen because it is a dyestuff known in the paper industry to have a bleedfastness of 1 to 2 bleeds (Considerable to Much bleed) in standard applications. The results here show that the coloring agent applied to the surface by the method of the invention increased the adherence of the coloring composition to the paper over the method where the coloring composition was applied throughout the paper.

Bleed Fastness Test: BASF method

Cut a 2.54 cm (1″) square of sample and two 5.08 cm (2″) squares of white filter paper (Whatman #1 can be used as filter pads).

Sandwich the sample between the filter paper and dip into test liquid. Common test liquids include, tap water, 50%/50% Isopropyl alcohol/water, milk, 1% IVORY™ soap, 2% dish detergent (specify the brand used), synthetic urine, WINDEX™ cleaner, FORMULA 409™ cleaner, etc.

Place the sandwich between two PLEXIGLAS™ plates.

Place the PLEXIGLAS™ plates in the “AATCC (American Association of Textile Chemist and Colorist) Perspiration Tester” and set the 0.908 kg (2 lb.) weight of the top section of the tester sitting on the sandwich.

After 15 minutes remove sample from filter paper and dry filter paper.

Visually evaluate amount of color transferred to the white filter paper using the Bleed Fastness “Grey Scale” Evaluation below.

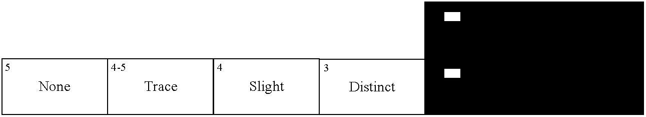

Light Fastness Test: BASF Method

Set up samples to be tested so that the lowest time of exposure is done first. Example: Need to run 1 hour and 2 hour exposures. Expose both for 1 hour then cover the 1 hour section and expose for another hour.

Keep a portion of sample unexposed as a control.

Attach samples firmly to revolving frame inside the Fade-ometer™. Set desired time using the Fade-ometer™ counter. The Fade-ometer™ model # 25/18—FT was supplied by Atlas Electric Device Co. utilizing a High Intensity Ultraviolet Light 2500 watt Xenon Burner Light source.

Set timer.

Turn “lamp igniter” (xenon lamp only) and “operator” switches on.

Turn timer switch on.

Unit should automatically stop after cycle is completed. Check to make sure unit has stopped before opening door. The light source can damage your eyesight. Check readout to ensure the cycle was completed.

Report visual comparisons and/or L, a, b, and Br values vs. unexposed control.

L, a, b, and Br. Test Results

The L value indicates depth of shade, and a lower number means a darker color. The “a” value represents how green or red a shade is with −a being greener and +a being redder. The “b” value represents how yellow or blue a shade is with −b being bluer and +b being yellower. “Br” is a measure of brightness. All values were generated using the MacBeth Color-eye Model # M2020PL.

Rub Test: BASF Method

1. Prepare a 10.16 cm×15.24 cm (4″×6″) sample and mount to a flat surface.

2. Affix a 5.08 cm×5.08 cm (2″×2″) white, lint free cotton cloth to the base of a 1 kg weight.

3. The sample can be analyzed for either dry rub or wet rub resistance.

a. For dry rub, place the weighted cloth onto the sample.

b. For wet rub, submerge the weighted cloth into a beaker of de-ionized water for 30 seconds Then remove the cloth allowing the excess water to be drained off until less than 1 drop every 5 seconds is observed. Then place the wet weighted cloth onto the sample.

4. Slide the weighted cloth material a minimum distance of 5.08 cm (2 inches) back and forth over the test sample for a total of 20 strokes (round trips).

5. Remove the cloth from the weight and compare to the visual test scale below.

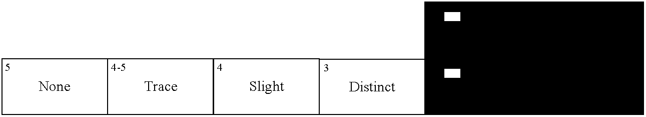

### EXAMPLE 4

Different dyes were used at different levels to determine the color values of coatings prepared from the composition. The composition contained 10 ml of ACRONAL® S504 binder (from BASF), the dye at 0.5 ml, 1 ml, or 2 ml, and water to make 100 ml of the composition. The dyes were the following SOLAR Q™ dyes from BASF: Yellow PR3351, Red PR336L, Red PR367L, Violet PR353L, and Blue PR355L. (WHAT WAS THE APPLICATION RATE?) The samples were color tested, and the results are shown in Table 2 below.

TABLE 2

| | L | a | b |
|---|---|---|---|
| Standard 1 | 84.55 | 1.12 | 32.93 |
| Standard 2 | 33.90 | 20.57 | 0.04 |
| Solar Q ™ Yellow PR335L | | | |
| 0.5 | 87.35 | 2.6 | 40.51 |
| 1 | 85.08 | 6.41 | 44.77 |
| 2 | 81.89 | 12.73 | 46.35 |
| Solar Q ™ Red PR336L | | | |
| 0.5 | 65.81 | 39.87 | 0.41 |
| 1 | 58.09 | 47.73 | 3.28 |
| 2 | 51.47 | 51.68 | 7.01 |
| Solar Q ™ Red PR367L | | | |
| 0.5 | 73.48 | 27.7 | −10.64 |
| 1 | 67.02 | 34.77 | −12.36 |
| 2 | 60.48 | 39.62 | −12.92 |
| Solar Q ™ Violet PR353L | | | |
| 0.5 | 46.82 | 20.37 | −36.13 |
| 1 | 37.79 | 19.51 | −36.49 |
| 2 | 32.74 | 15.99 | −30.28 |
| Solar Q ™ Blue PR335L | | | |
| 0.5 | 54.11 | 5.49 | −39.14 |
| 1 | 45.63 | 7.44 | −44.44 |
| 2 | 37.95 | 8.99 | −42.95 |

It should be appreciated that the present invention is not limited to the specific embodiments described above, but includes variations, modifications and equivalent embodiments defined by the following claims.

What is claimed is:

1. A method comprising:
a. providing a paper substrate; and
b. applying a coloring composition comprising a binder and a coloring agent to form a colored paper, wherein the coloring composition is non-white.

2. The method of claim 1, wherein the coloring composition further comprises at least one of a filler, a viscosity modifier, a dispersant, a lubricant, and a pH adjusting agent.

3. The method of claim 1, wherein the coloring composition further comprises a filler, a viscosity modifier, a dispersant, and a lubricant.

4. The method of claim 1, wherein the coloring agent further comprises a cationic fixing agent.

5. The method of claim 1, wherein the coloring composition does not contain a cationic fixing agent.

6. The method of claim 1, wherein the coloring agent is selected from the group consisting of a direct dye, a basic dye, an acid dye, a reactive dye, a solvent dye, a dispersed dye, a leather dye, a natural dye, a sulfur dye a vat dye, a synthetic pigment, a naturally occurring pigment, a security dye, and mixtures thereof.

7. The method of claim 1, wherein the binder is selected from the group consisting of a styrene butadiene polymer dispersion, a styrene butadiene acrylonitrile polymer dispersion, an acrylic polymer dispersion, a polyvinyl acetate, a polyvinyl acrylate, a starch, and mixtures thereof.

8. The method of claim 1, wherein the binder further comprises a polymer selected from the group consisting of a polyurethane, a polyether, a polyester, a melamine-formaldehyde polymer, a vinyl halide, a vinylidene halide, a poly(ethyleneimine), a poly(vinyl amine), a poly(amine), a poly(imine), a poly(acrylate), and mixtures thereof.

9. The method of claim 2, wherein the filler is selected from the group consisting of silica, calcium carbonate, chalk, clay, titanium dioxide, aluminum oxides, talc and diatomaceous earth, mica, kaolin, barium sulfate, magnesium carbonate, vermiculite, graphite, carbon black, and mixtures thereof.

10. The method of claim 2, wherein the viscosity modifier is selected from the group consisting of an associative thickener, an alkali swellable thickener, an alkali soluble thickener, a polymer thickener, and mixtures thereof.

11. The method of claim 2, wherein the viscosity modifier is selected from the group consisting of a polyvinyl alcohol, a cellulose derivative, a hydroxyethyl cellulose, a hydroxypropyl cellulose, a carboxymethyl cellulose salt, a polyether compound, a urethane modified polyether compound, a polycarboxylic acid compound, a sodium salt of a polycarboxylic acid compound, a polyvinylpyrrolidone, a polyoxyethylene derivative, a polyethylene glycol ether, a polyethylene glycol distearate, a sodium alginate, an inorganic material, a sodium silicate, bentonite, and mixtures thereof.

12. The method of claim 2, wherein the dispersant is selected from the group consisting of an inorganic dispersing agent, a sodium salt of a polycarboxylic acid, a sodium salt of fused naphthalene sulfonate, an ammonium salt of fused naphthalene sulfonate, a polyoxyalkylene alkyl ether of phenol ether, a sorbitan fatty acid ester, a polyoxyalkylene fatty acid ester, a glycerin fatty acid ester, a polyoxyethylene styrene phenol, a sodium tripolyphosphate, a sodium hexametaphosphate, an organosilanol derivative of tung oil, an organosilanol derivative of linseed oil, a rapeseed oil, and mixtures thereof.

13. The method of claim 2, wherein the lubricant is selected from the group consisting of calcium stearate, tall oil, polyethylene glycol, a polyethylene emulsion, and mixtures thereof.

14. The method of claim 2, wherein the pH adjusting agent is selected from the group consisting of sodium hydroxide, potassium hydroxide, sodium hydrogen carbonate, ammonium hydroxide, ammonia, amines, triethanolamine, 3-dimethylaminoethanol, and mixtures thereof.

15. The method of claim 1, wherein at least one of:
a. the binder is present in the coloring composition in an amount from about 0.1 to about 99.9% by weight of the total wet weight of the binder in the total coloring composition; and
b. the coloring agent is present in the coloring composition in an amount from about 0.01 to about 99.9% by weight of the total coloring composition.

16. The method of claim 1, wherein at least one of:
a. the binder is present in the coloring composition in an amount from about 5 to about 60% by weight of the total wet weight of the binder in the total coloring composition; and
b. the coloring agent is present in the coloring composition in an amount from about 0.1 to about 50% by weight of the total coloring composition.

17. The method of claim 2, wherein at least one of:
a. the binder is present in the coloring composition in an amount from about 0.1 to about 99.9% by weight of the total wet weight of the binder in the total coloring composition;
b. the coloring agent is present in the coloring composition in an amount from about 0.01 to about 99.9% by weight of the total coloring composition;
c. the filler is present in the coloring composition in an amount from 0 to about 65% by weight of filler in the total weight of the coloring composition;
d. the viscosity modifier is present in the coloring composition in an amount from 0 to about 15% by weight based on the total weight of the coloring composition;
e. the dispersant is present in the coloring composition in an amount from 0 to about 10% by weight based on the total weight of the coloring composition; and
f. the lubricant is present in the coloring composition in an amount from 0 to about 10% by weight based on the total weight of the coloring composition.

18. The method of claim 1, wherein at least one of:
a. the colored paper has a light fastness of at least about 80 hours as measured by BASF Lightfastness Test;
b. the colored paper has a bleed of no more than about 4 (Slight) as measured by BASF Bleed Fastness Test; and
c. the colored paper has a rub off of no more than about 4 (Slight) as measured by BASF Rub Test.

19. The method of claim 1, wherein the colored paper has 30% to 70% less coloring agent and the same color shade as compared to a colored paper prepared by a method of coloring pulp and forming a paper.
